(19) United States
(12) Patent Application Publication
(10) Pub. No.: US 2025/0078181 A1
(43) Pub. Date: Mar. 6, 2025

(54) SYSTEM AND METHOD FOR GENERATING AND UPDATING AN INTERACTIVE TRAVEL ITINERARY

(71) Applicant: TH2CONNECT, LLC, Elkhart, IN (US)

(72) Inventors: Mary Heneen, Centennial, CO (US); Josh Knepfle, Cincinnati, OH (US)

(21) Appl. No.: 18/823,081

(22) Filed: Sep. 3, 2024

Related U.S. Application Data
(60) Provisional application No. 63/580,068, filed on Sep. 1, 2023.

(51) Int. Cl. G06Q 50/14; G06Q 10/1093

(52) U.S. Cl. CPC G06Q 50/14; G06Q 10/1093

(57) ABSTRACT

Systems and methods for generating and updating an interactive travel itinerary are disclosed, based on data gathered from a user and additional data from other users and third parties. The data may relate to general travel preferences, specific travel plans, and/or potential stops along a trip. A custom itinerary can be generated based on the data, which can be updated in real time.

### CROSS-REFERENCE

This application claims priority to U.S. Provisional Patent App. No. 63/580,068, filed on Sep. 1, 2023, the contents of which are incorporated by reference herein in their entirety.

### BACKGROUND

Vacation travel by road (“road trips” or “road tripping”) is a popular activity. A road trip can include travel by car (including light trucks and SUVs), by car with a camping trailer, or by Recreational Vehicle (“RV”). One alluring aspect of road tripping is the ability to stop along the way during the trip at various Points of Interest (“POI”). The POI can be customized according the vacationers' interests and travel timeframe. Stops for food and accommodations (hotel, motel, campsite, etc.) can likewise be customized. However, the sheer volume of potential stops can make selecting a road trip route and itinerary a daunting task.

### SUMMARY

In response to the above-described challenges, the disclosure presents a system and method for generating and updating an interactive travel itinerary. The method includes gathering data from a user with respect to the user's general travel preferences and specific travel plans. This data is combined with additional data from other users and third parties about potential stops along the trip and used to generate a custom itinerary. The itinerary can be updated in real time in response to an express request from the user, a change in the user's circumstances, or in response to changes in external circumstances.

### BRIEF DESCRIPTION OF THE DRAWINGS

FIG. 1 is a block diagram illustrating one example of a computing device suitable for use in generating an interactive road trip itinerary.

FIG. 2 is a diagram illustrating an example platform for implementing an interactive travel itinerary, in accordance with the present disclosure.

FIG. 3 is a flow chart illustrating an example data flow used in generating a User Passport for use in an interactive travel itinerary, in accordance with the present disclosure.

FIG. 4 is a flow chart illustrating an example data flow used in generating a Points of Interest database for use in an interactive travel itinerary, in accordance with the present disclosure.

FIG. 5 is a flow chart illustrating an example computerized method for generating list of potential stops for use in an interactive travel itinerary, in accordance with the present disclosure.

FIG. 6 is a flow chart illustrating a portion of an example computerized method for updating a User Passport for use in an interactive travel itinerary, in accordance with the present disclosure.

FIG. 7 is a flow chart illustrating a portion of an example computerized method for updating a User Passport for use in an interactive travel itinerary, in accordance with the present disclosure.

FIG. 8 is a flow chart illustrating an example computerized method for generating and updating an interactive travel itinerary, in accordance with the present disclosure.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein can include, but are not limited to, for example, components developed after development of the disclosed technology.

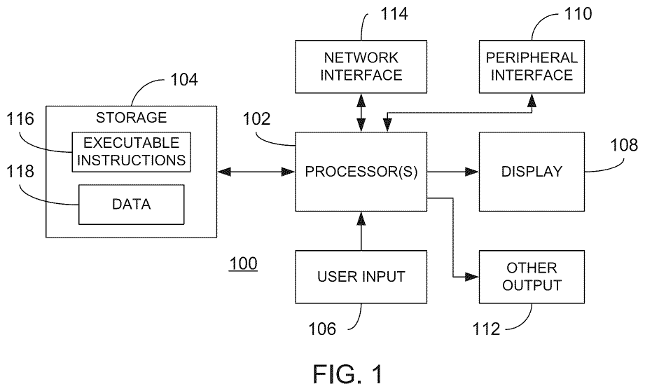

Referring now to the Figures, in which like reference numerals represent like parts, various embodiments of the computing devices and methods will be disclosed in detail. FIG. 1 is a block diagram illustrating one example of a computing device 100 suitable for use in generating an Interactive Travel Itinerary.

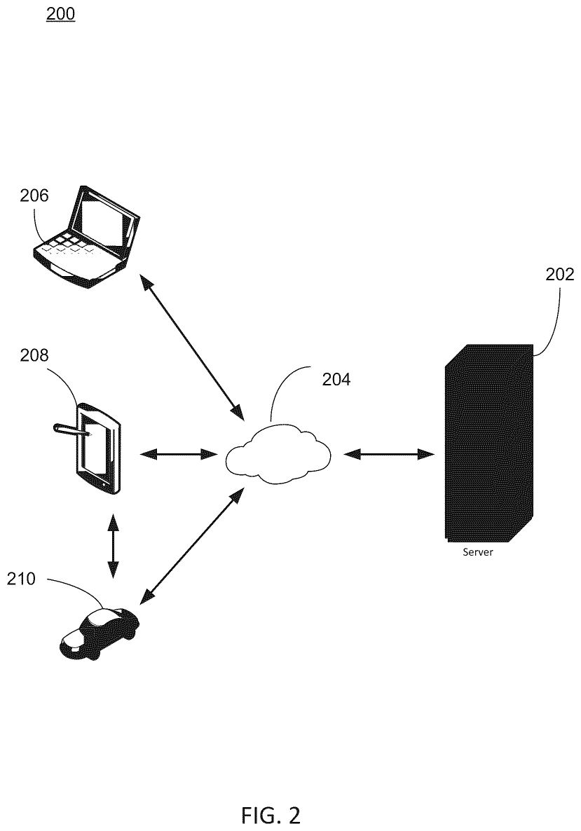

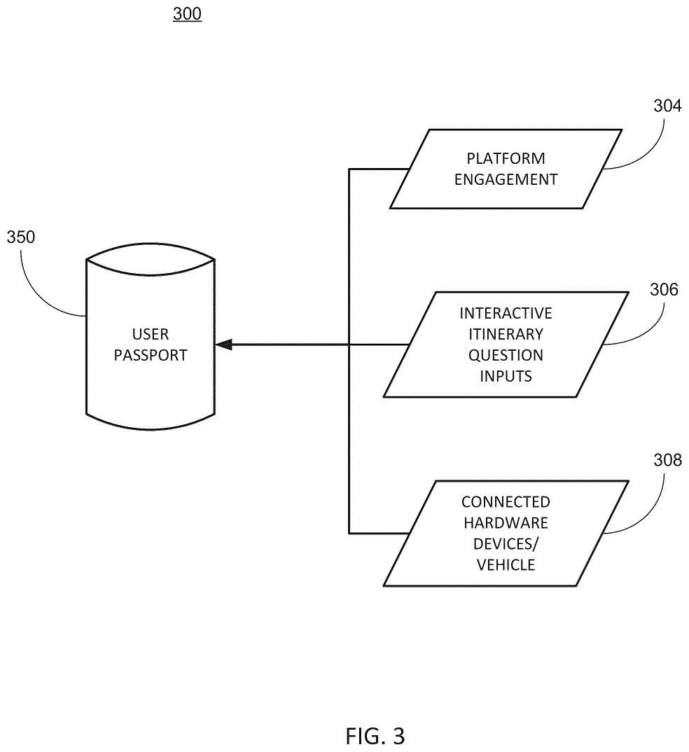

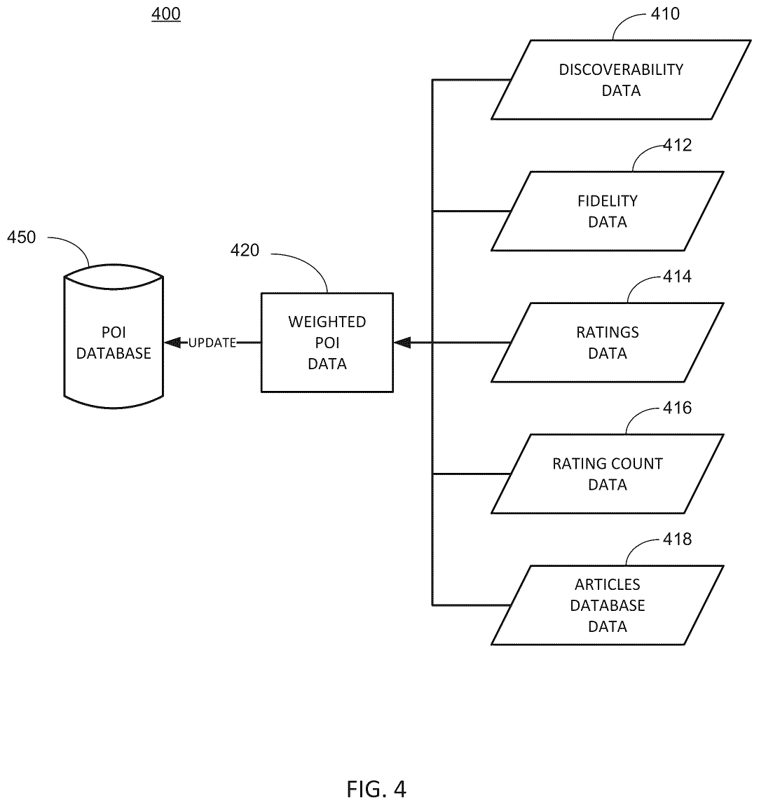

FIG. 1 illustrates a representative computing device 100 that can be used to implement the teachings of the instant disclosure. The device 100 can be used to implement, for example, one or more components of the system shown in FIG. 4, as described in greater detail below. As another example, the device 100 can be used to implement the methods of FIG. 2 or FIG. 3, as described in greater detail below. The device 100 includes one or more processors 102 operatively connected to a storage component 104. The storage component 104, in turn, includes stored executable instructions 116 and data 118. In an embodiment, the processor(s) 102 can include one or more of a microprocessor, microcontroller, digital signal processor, co-processor or the like or combinations thereof capable of executing the stored instructions 116 and operating upon the stored data 118. Likewise, the storage component 104 can include one or more devices such as volatile or nonvolatile memory including but not limited to random access memory (RAM) or read only memory (ROM). Further still, the storage component 104 can be embodied in a variety of forms, such as a hard drive, optical disc drive, floppy disc drive, flash memory, etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 can include one or more user input devices 106, a display 108, a peripheral interface 110, other output devices 112, and a network interface 114 in communication with the processor(s) 102. The user input device 106 can include any mechanism for providing user input to the processor(s) 102. For example, the user input device 106 can include a keyboard, a mouse, a touch screen, microphone and suitable voice recognition application, or any other means whereby a user of the device 100 can provide input data to the processor(s) 102. The display 108 can include any conventional display mechanism such as a cathode ray tube (CRT), flat panel display, projector, or any other display mechanism known to those having ordinary skill in the art. In an embodiment, the display 108, in conjunction with suitable stored instructions 116, can be used to implement a graphical user interface. Implementation of a graphical user interface in this manner is well known to those having ordinary skill in the art. The peripheral interface 110 can include the hardware, firmware and/or software necessary for communication with various peripheral devices, such as media drives (e.g., magnetic disk, solid state, or optical disk drives), other processing devices, or any other input source used in connection with the instant techniques. For example, the peripheral interface can be a Universal Serial Bus (USB). Likewise, the other output device(s) 112 can optionally include similar media drive mechanisms, other processing devices, or other output destinations capable of providing information to a user of the device 100, such as speakers, LEDs, tactile outputs, etc. Finally, the network interface 114 can include hardware, firmware, and/or software that allows the processor(s) 102 to communicate with other devices via wired or wireless networks, whether local or wide area, private or public, as known in the art. For example, such networks can include the World Wide Web or Internet, or private enterprise networks, as known in the art.

While the computing device 100 has been described as one form for implementing the techniques described herein, those having ordinary skill in the art will appreciate that other, functionally equivalent techniques can be employed. For example, as known in the art, some or all of the functionality implemented via executable instructions can also be implemented using firmware and/or hardware devices such as application specific integrated circuits (ASICs), programmable logic arrays, state machines, etc. Furthermore, other implementations of the device 100 can include a greater or lesser number of components than those illustrated. Once again, those of ordinary skill in the art will appreciate the wide number of variations that can be used is this manner. Further still, although a single computing device 100 is illustrated in FIG. 1, it is understood that a combination of such computing devices can be configured to operate in conjunction (for example, using known networking techniques) to implement the teachings of the instant disclosure.

FIG. 2 illustrates an example platform 200 that can be used to implement the system and methods described in this disclosure. The platform 200 includes one or more computer severs 202 and a communications network (e.g., the Internet) 204. The computer servers 202 host data about users, host travel data (including map data, POI data, accommodations data), perform analysis, generate Interactive Travel Itinerary described in this disclosure, and facilitate communication between devices included in the platform 200. The platform 200 can also include computing devices 100 including: user computers 206 that are connected to the platform 200, user mobile devices 208 (e.g., smartphones, tablets, etc.) that are connected to the platform 200, and user vehicles 210 that are connected to the network. In some examples, the user vehicles 210 can be connected to the network through an Internet of Things (“IoT”) protocol. In some examples, the user vehicles 210 can be connected to the user mobile devices 208 to exchange data with them. In some examples, the user vehicles 210 can also be connected to the communications network 204 through the user mobile devices 208.

User vehicles 210 can include cars, motorcycles, light trucks, trailers, and RVs, among other examples. Data from the user vehicles 210 can include, but is not limited to: fuel/charge status, GPS location, speed, parking status (e.g., whether RV parking stabilizers are deployed), and vehicle maintenance information.

FIG. 3 illustrates one example data flow 300 for generating a User Passport 350. A User Passport 350 is an input to an example interactive travel itinerary, as further described below. A User Passport 350 is a composite of a user's preferences, goals, and sensitivities. A User Passport 350 can include direct input from the user, data from the user's engagement with the platform, and data from the user's computing devices and vehicles 206, 208, 210.

Platform engagement 304 includes passively enhancing a User Passport 350 to predict a user's future travel preferences based on the user's activity on the platform 200. For example, platform engagement 304 can include data concerning the categories of places a user selects, the filters the user engages when searching for places, the locations a user saves in the platform, the locations the user actually visits, the vehicle(s) the user selects, the user's ratings of locations, content the user shares on the platform, User Generated Content (“UGC”) sentiment analysis, and the types of computing devices the user accesses the platform with. Categories of places can include restaurants, accommodations, POIs, etc. Locations saved in the platform can include locations that the user considers visiting while using the platform and saves or “pins” in the platform. Shared content can include, for example, social media posts.

Interactive itinerary question inputs 206 can include the user's answers to direct questions. These questions can be posed by the platform to generate an Interactive Travel Itinerary for an upcoming trip. Example questions can include: time and date to depart, location of departure, time and date of arrival at a destination, location of a destination, maximum travel time during a travel segment, and other user preferences. These user questions can be general or specific to a particular road trip.

Connected hardware devices and/or vehicles 308 can be used in various example to provide localized suggestions of locations suggestions, to optimize a route for speed or for fuel/charge efficiency, and to identify upcoming segments of the trip that are expected to have little or no network access (e.g., no mobile phone service) to preemptively save appropriate data offline. Likewise, updates from the user's connected hardware devices and/or vehicles 308 can provide live data to the platform 200 to regenerate and/or modify the user's interactive itinerary, as described below. For example, a vehicle low fuel/charge indication could suggest a change of itinerary to the user to stop earlier. Such a suggested stop can include a change of meal location or add a POI near the fueling/charging location.

FIG. 4 illustrates a data flow 400 for generating a POI database 450. Data inputs can include discoverability data 410, fidelity data 412, ratings data 414, rating count data 416, and one or more articles databases 418. Discoverability data 410 can include data influencing the ability of a user to discover a place, and can include: filter tags, geographical location, geographical distance from another location, and locations ranking data. Discoverability data 410 can also include a designation as an “extraordinary place” and/or can include a numerical value from a POI Database. Fidelity data 412 can include a measure of how complete the data for a particular location is. For example, fidelity data 412 can include a percentage of relevant location attributes with non-nil or non-null values. As a further example, a if a location lacks hours of operation data (opening hours), that could be a nil or null value and would lower its fidelity score. Ratings data 414 can include ratings for a location by users within the platform and/or can include ratings data from third-party services (e.g., Yelp®, Google®, etc.). Ratings count data 416 can include the total number of ratings within the platform and/or on third-party partner platforms. In some examples, the ratings count value can be capped at a number above which additional ratings no longer increase the usefulness of the ratings data (e.g., 1,000 ratings). Articles database data 418 can include data indicating if the platform includes articles about the location and/or if third-party publications include articles about the location, which can increase the usefulness of the location being considered.

After the various data are collected, weighted POI data 420 is generated. Generation of weighted POI data 420 involves applying weights to each data type according to its usefulness. In one example embodiment, the weights applied to each data type can be fixed. In another example, the weights applied to each data type can be regularly updated based interactive feedback from all users of the platform. In another example, the weights applied to each data type can be regularly updated based interactive feedback from a particular user, e.g., the weights applied to the data will be different for each user. In another example, weights can be updated in real time based on interactive feedback from one or multiple users. In another example weights can be updated using machine learning techniques, as will be understood by persons skilled in the art.

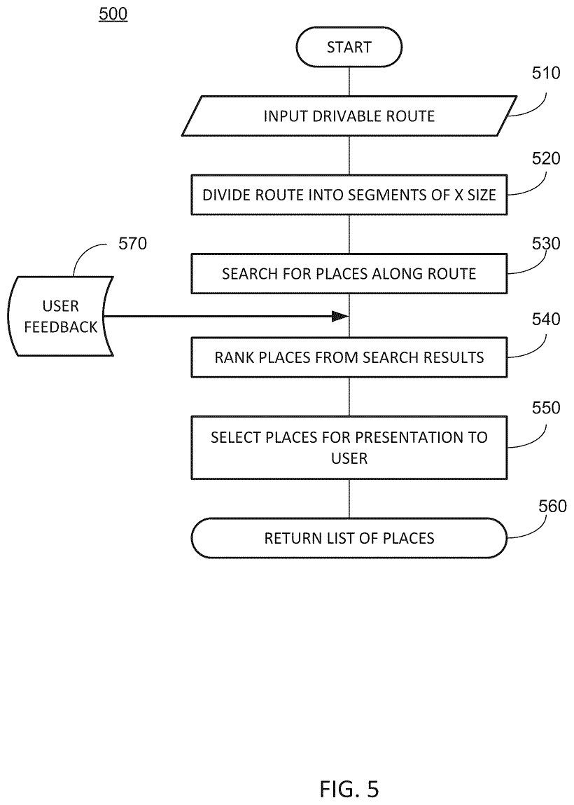

FIG. 5 is a flow chart illustrating one example method for generating a list of places 500 for use in an Interactive Travel Itinerary for a user. At 510, a drivable route is received. In one example, a drivable route can include specific directions from an origin location to one or more primary destinations. As a further example, a drivable route can include Chicago, IL, as an origin location and can include St. Louis, MO, Kansas City, MO, and Denver, CO as primary destinations.

At 520, the drivable route is divided in segments of a particular size. In one example, the segments can be determined according the fuel/charge range of a particular vehicle or generic estimated vehicle. In another example, the segments can be determined according a maximum driving time. In another example, the segments can be determined by a discrete user input (e.g., 200 miles). In other examples, other methods can be used to divide the route into segments, as will be understood by those skilled in the art.

At 530, a search is conducted for locations along the route. In one example, the search parameters can include the distance of the location from the route (e.g., the radius along the route), intervals along the route, data from the User Passport 350 for the user, and relevancy data from the POI database 450. In other examples, these data can be weighted. In other examples, a fewer or greater number of categories of data can be used as search parameters.

At 540, the search results are ranked. In one example, the search results can be ranked according to their relevance to the user and the route. Additional criteria can also be used to rank the search results.

At 550, the top search results are selected for presentation to the user. In one example, a fixed number of results can be selected. In another example, the number of locations can be set by the user. In another example, the number of locations can be determined based on other parameters of the route and/or itinerary.

At 560, the list of selected locations is returned.

At 570, user feedback from based on the Interactive Travel Itinerary can be fed back into the method to improve the results.

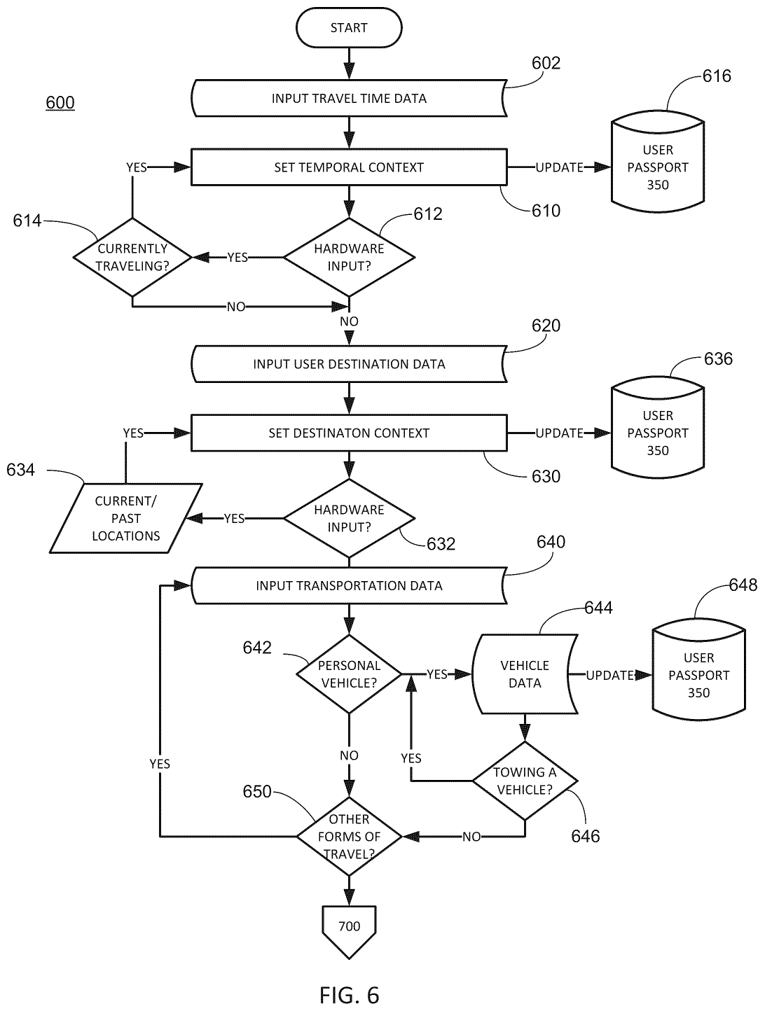

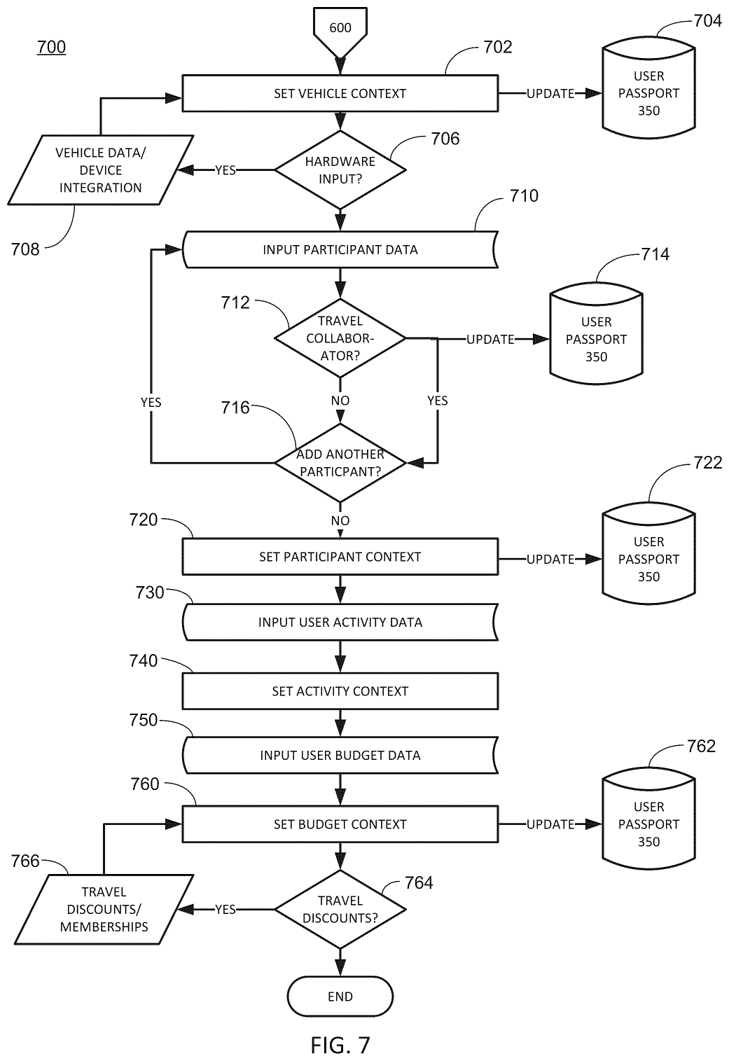

FIGS. 6 and 7 illustrate a method for updating the User Passport 350 in the context of generating a specific interactive travel itinerary. At 602, the user inputs travel time data. In various examples, travel time data can include a year of travel, a season of travel (e.g., spring), a month or months of travel, and/or specific dates of travel. At 610, a temporal context is set. In one example, the temporal context can include the specific travel data input by the user at 602. In another example, the temporal context can also include previous travel time data input by the user. Retaining previous data can improve prediction of travel dates and location suggestions. At 616, the User Passport 350 is updated with the temporal context. At 612, the method checks for input from user hardware devices or vehicles. In various examples, such hardware or vehicle data can help to identify real time travel to enhance location recommendations. In some examples, if hardware or vehicle data is available, such data can also trigger regeneration of the Interactive Travel Itinerary or notify the user that such a regeneration is available. If hardware input is available, the User Passport 350 can be further updated.

At 630, the user inputs travel destination data. In various examples, travel destination data can include the user's interests (e.g., gourmet dining, hiking, live entertainment, etc.); geographic features (e.g., beaches, mountains, etc.); climate (e.g., warm, cold, dry, lush, etc.); region (e.g., Midwest, Northeast, etc.); individual states or provinces; individual cities; individual POIs (e.g., Grand Canyon, other national parks, etc.); and/or specific addresses. At 630, a destination context is set. In one example, the destination context can include the specific destination data input by the user at 620. In another example, the destination context can also include previous destination data input by the user. Retaining previous data can improve prediction of location suggestions. At 636, the User Passport 350 is updated with the destination context. At 632, the method checks for input from user hardware devices or vehicles. In various examples, such hardware or vehicle data can help to identify real time travel or past travel to enhance location recommendations. In some examples, if hardware or vehicle data is available, such data can also trigger regeneration of the Interactive Travel Itinerary or notify the user that such a regeneration is available. If hardware input is available, the User Passport 350 can be further updated.

At 640, the user inputs transportation data. In various examples, transportation data can include modes of travel, such as: airplane, train, bus, ride share, and/or personal vehicle. At 642, the user is prompted 644 for additional information concerning any personal vehicles specified for the itinerary. In one example, such data can include the type of vehicle (e.g., car, truck motorcycle, RV, etc.). At 646, the user is prompted to identify any vehicle or trailer that will be towed. For example, a user traveling by RV can be towing a secondary vehicle like a car or motorcycle. Likewise, a use traveling by car or truck can be towing a camper trailer. At 648, the User Passport 350 is updated with all of the vehicle data. At 650, the user is prompted to identify any additional modes of travel.

At 702, a vehicle context is set. In one example, the vehicle context can include the specific travel input by the user at 640. In another example, the vehicle context can also include previous vehicle data input by the user. Retaining previous data can improve prediction of travel timing and location suggestions. At 704, the User Passport 350 is updated with the vehicle context. At 706, the method checks for input from user hardware devices or vehicles. In various examples, such hardware or vehicle data can simplify vehicle selection for future itineraries, can enhance route optimizations for fueling/charging, and can enhance route optimizations for maintenance operations. In some examples, if hardware or vehicle data is available, the data, such as maintenance notifications or error messages can also trigger regeneration of the Interactive Travel Itinerary or notify the user that such a regeneration is available. If hardware input is available, the User Passport 350 can be further updated.

At 710, the user inputs participant data. In various examples, participant data can include multiple types of participants:
a Follower can be someone who would like to receive travel updates (e.g., a family member)
an Advisor can be someone who may be assisting the user with travel recommendations
a Co-Traveler can be someone joining the trip. The Co-Traveler category can include sub-categories such as Adult, Child, and/or Pet.

At 712, user is prompted to identify any other participants as Collaborators. A Collaborator is an active participant in the trip, although a Collaborator may not necessarily be joining a trip. For example, an Advisor can be a Collaborator because he or she is actively advising on the trip from afar. In contrast, a Child or Pet Co-Traveler may be joining the trip but may not be actively collaborating. At 714, the User Passport 350 is updated with travel Collaborator data for the trip. At 720, a participant context is set. In one example, the participant context can include the specific participant data input by the user at 710. In another example, the participant context can also include previous participant data input by the user. Retaining previous data can improve prediction of travel timing and location suggestions. For example a user with Children as Co-Travelers can be provided with suggestions for different POIs or shorter travel segments. At 722, the User Passport 350 is updated with the participant context.

At 730, the user inputs activity data. In various examples, activity data can include categories of locations (e.g., campgrounds, hotels, “family friendly,” etc.); user interests (e.g., hiking, swimming, golfing, etc.); and/or POIs (e.g., St. Louis Arch, Pike's Peak, etc.). At 740, an activity context is set. In one example, the activity context can include the specific activity input by the user at 720. In another example, the activity context can also include previous activity data input by the user. Retaining previous data can improve prediction of location suggestions. At 742, the User Passport 350 is updated with the activity context.

At 750, the user inputs budget data. In various examples, budget data can include categories of budget (e.g., frugal, luxurious, etc.); a total budget; and/or a categorical budget (e.g., $200 per night for accommodations, $150 per day for food, etc.). At 760, a budget context is set. In one example, the budget context can include the specific budget input by the user at 750. In another example, the budget context can also include previous budget data input by the user. Retaining previous data can improve prediction of location suggestions. At 762, the User Passport 350 is updated with the budget context. At 764, the method checks for travel discounts and/or memberships. In one example, the user can be prompted to enter any travel discounts and/or memberships. In another example, the User Passport can be searched for any relevant data. In another example, databases of third-party partners can be searched for relevant data. At 766, the budget context is updated with data on for travel discounts and/or memberships.

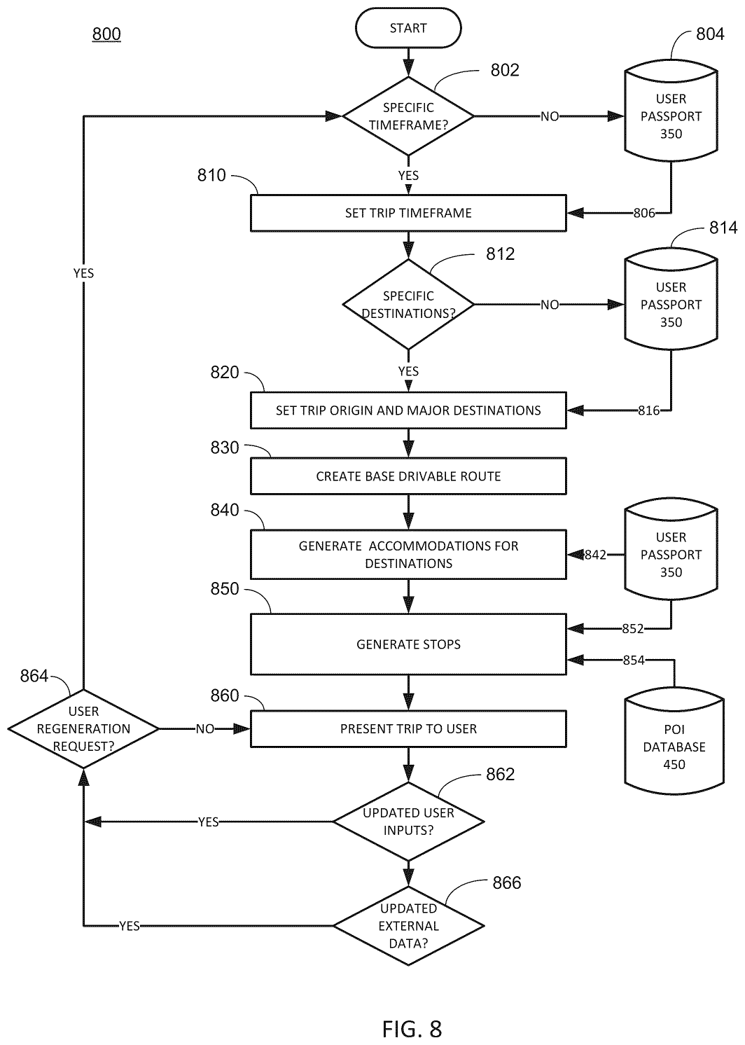

FIG. 8 illustrates a method for generating and updating an interactive travel itinerary. At 802, the method checks if a specific travel timeframe has been set. If not, at 804, the User Passport 350 is queried to determine a suitable travel timeframe. For example, a user may request an itinerary without parameters in order to receive a suggested vacation based on past trips. At 806, the relevant timeframe data from the User Passport is returned. At 810, the timeframe for the trip is set.

At 812, the method checks if specific destinations have been set. If not, at 844, the User Passport 350 is queried to determine a suitable destinations. At 816, the relevant destination data from the User Passport is returned. At 820, the trip origin and major destinations are set.

At 830, a drivable route is determined based on the trip origin and major destinations.

At 840, recommendations are generated for accommodations based on the trip timeframe and the trip origin and major destinations. At 854, inputs to the recommended accommodations can include data from the User Passport 350.

At 850, recommendations are generated for additional stops along the route based on the trip timeframe, the trip origin, major destinations, and the recommended accommodations. At 852, inputs to the recommended additional stops can include data from the User Passport 350. At 854, inputs to the recommended additional stops can include data from the POI database 450.

At 860, the Interactive Travel Itinerary is presented to the user.

At 862, the user can provide additional input to improve the interactive travel itinerary. In one example, the user provides immediate feedback concerning the interactive travel itinerary. For example, the user can reject or change the major destinations, the drivable route, the accommodations, and/or the recommended stops. In this example, the itinerary will be regenerated and the new itinerary will be presented to the user until the user is satisfied. In another example, the user can update the user inputs during the trip, for example choosing a longer trip or changing a major destination. In this example, the itinerary will be regenerated based on the new user input, but also based on the trip details up to that point. For example, if the user has already visited a stop for hiking, the regenerated itinerary can be more or less likely to recommend another stop for hiking based on how much the User Passport 350 indicates the user enjoys hiking. A casual hiker may not be recommended a second hiking stop; an avid hiker may be recommended several more. In this way, continued use of the platform generates consistently improving recommendations.

In various other examples, updated user inputs can also include data from the user's hardware devices and/or vehicles. In one example, a user's vehicle could provide data indicating that the vehicle needs unexpected maintenance. In such an event, the Interactive Travel Itinerary could notify the user of the issue and prompt the user to decide if the itinerary should be regenerated. Similarly, if location data from the user's hardware devices and/or vehicle indicate that the user is off course, the Interactive Travel Itinerary could notify the user of the issue and prompt the user to decide if the itinerary should be regenerated. Another example can include a low fuel/charge state for the user's vehicle. The user can also provide ratings for stops along the trip. If these ratings indicate that the user is dissatisfied with the trip, the Interactive Travel Itinerary can prompt the user to decide if the itinerary should be regenerated.

At 866, the Interactive Travel Itinerary can also incorporate external data. In one example, if new external data indicates that one of the scheduled stops is permanently closed, has changed is operating hours, or its ratings have significantly changed, the Interactive Travel Itinerary can prompt the user to decide if the itinerary should be regenerated. In another example, if a portion of the drivable route becomes impassable, the Interactive Travel Itinerary can prompt the user to decide if the itinerary should be regenerated. In another example, if an accommodation is unexpectedly overbooked, the Interactive Travel Itinerary can prompt the user to decide if the itinerary should be regenerated. Other examples are possible using any data that can be made readily available to the platform.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The design and functionality described in this application is intended to be exemplary in nature and is not intended to limit the instant disclosure in any way. Those having ordinary skill in the art will appreciate that the teachings of the disclosure can be implemented in a variety of suitable forms, including those forms disclosed herein and additional forms known to those having ordinary skill in the art. For example, one skilled in the art will recognize that executable instructions can be stored on a non-transient, computer-readable storage medium, such that when executed by one or more processors, causes the one or more processors to implement the method described above.

As used in this application, the terms “component,” “module,” “system” and the like are intended to include a computer-related entity, such as but not limited to hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions can be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions can also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure can provide for a computer program product, comprising a computer-usable medium having a computer-readable program code or program instructions embodied therein, said computer-readable program code adapted to be executed to implement one or more functions specified in the flow diagram block or blocks. The computer program instructions can also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

1-7. (canceled)

8. A method for generating an interactive travel itinerary, comprising:
generating, using a processor, an initial drivable route based on travel timeframe data, origin location data, and destination location data;
retrieving, from a database at the processor, user travel preference data;
determining, using the processor, at least one recommended stop located along the initial drivable route based on the user travel preference data;
displaying, using the processor on a user interface, the initial drivable route and the at least one recommended stop;
receiving, from the user interface at the processor, user feedback input related to the initial drivable route and the at least one recommended stop;
generating, using the processor, a revision to the at least one recommended stop based on the user feedback input; and
displaying, using the processor on the user interface, the revision to the at least one recommended stop.

9. The method of claim 8:
further comprising receiving one or more of the travel timeframe data, the origin location data, or the destination location data at the processor from the user interface;
wherein generating the initial drivable route comprises generating the initial drivable route based on one or more of the received travel timeframe data, the received origin location data, or the received destination location data.

10. The method of claim 8:
further comprising determining one or more of the travel timeframe data, the origin location data, or the destination location data based on the user travel preference data retrieved from the database;
wherein generating the initial drivable route comprises generating the initial drivable route based on one or more of the determined travel timeframe data, the determined origin location data, or the determined destination location data.

11. The method of claim 8, wherein the user travel preference data comprises one or more of direct user input data, user activity data, or connected device data.

12. The method of claim 11, wherein the direct user input data comprises answers received on the user interface in response to travel itinerary questions.

13. The method of claim 11, wherein the user activity data comprises one or more of user selection data, user filter data, user saved location data, user visited location data, vehicle data, user rating data, user shared content data, or user generated content sentiment analysis data.

14. The method of claim 11, wherein the connected device data comprises one or more of real time location data or vehicle status data.

15. The method of claim 8, wherein determining the at least one recommended stop comprises determining the at least one recommended stop further based on the travel timeframe data, the origin location data, and the destination location data.

16. The method of claim 8, wherein determining the at least one recommended stop comprises determining the at least one recommended stop further based on point of interest data received from the database.

17. The method of claim 16, further comprising generating the point of interest data based on one or more of point of interest discoverability data, point of interest fidelity data, point of interest ratings data, point of interest rating count data, or point of interest article data.

18. The method of claim 17, further comprising weighting the point of interest data based on an indication of usefulness.

19. The method of claim 8, wherein the at least one recommended stop comprises a plurality of recommended stops that are ranked based on the user travel preference data and the initial drivable route.

20. The method of claim 8, wherein the at least one recommended stop comprises one or more of an accommodation stop or a point of interest stop.

21. The method of claim 8, wherein the user feedback input comprises one or more of user input received on the user interface or connected device data.

22. The method of claim 8, further comprising:
generating, using the processor, a revision to the initial drivable route based on the user feedback input; and
displaying, using the processor on the user interface, the revision to the initial drivable route.

23. A system for generating an interactive travel itinerary, comprising:
a user interface;
a database comprising user travel preference data;
a processor in communication with the user interface and the database, the processor configured to:
generate an initial drivable route based on travel timeframe data, origin location data, and destination location data;
retrieve user travel preference data from the database;
determine at least one recommended stop located along the initial drivable route based on the user travel preference data;
display, on the user interface, the initial drivable route and the at least one recommended stop;
receive, from the user interface, user feedback input related to the initial drivable route and the at least one recommended stop;
generate a revision to the at least one recommended stop based on the user feedback input; and
display, on the user interface, the revision to the at least one recommended stop.

24. The system of claim 23, wherein the processor is further configured to determine one or more of the travel timeframe data, the origin location data, or the destination location data based on the user travel preference data retrieved from the database, and wherein the processor is configured to generate the initial drivable route by generating the initial drivable route based on one or more of the determined travel timeframe data, the determined origin location data, or the determined destination location data.

25. The system of claim 23, wherein the processor is configured to determine the at least one recommended stop by determining the at least one recommended stop further based on the travel timeframe data, the origin location data, and the destination location data.

26. The system of claim 23, wherein the processor is configured to determine the at least one recommended stop by determining the at least one recommended stop further based on point of interest data received from the database.

27. The system of claim 23, wherein the at least one recommended stop comprises a plurality of recommended stops that are ranked based on the user travel preference data and the initial drivable route.
